(19) United States
(12) Patent Application Publication
(10) Pub. No.: US 2004/0255162 A1
(43) Pub. Date: Dec. 16, 2004

(54) Security gateway system and method for intrusion detection

(76) Inventors: Byoung Koo Kim, Daejeon (KR); Ik-Kyun Kim, Daejeon (KR); Jong Kook Lee, Daejeon (KR); Ki Young Kim, Daejeon (KR); Jong Soo Jang, Daejeon (KR)

Correspondence Address: JACOBSON HOLMAN PLLC, 400 SEVENTH STREET N.W., SUITE 600, WASHINGTON, DC, 20004, US

(21) Appl. No.: 10/737,742

(22) Filed: Dec. 18, 2003

(30) Foreign Application Priority Data
May 20, 2003 (KR) 10-2003-31992

(51) Int. Cl. G06F 11/30

(52) U.S. Cl. 713/201; 709/224

(57) ABSTRACT

A security gateway system for detecting an intrusion has an intrusion pattern table, a hardware intrusion detecting unit, and a kernel intrusion detecting unit. The intrusion pattern table includes a header pattern table having header pattern information and a data pattern table having data pattern information. The hardware intrusion detecting unit collects a packet and checks whether a header section of the packet is matched with the header pattern information. The kernel intrusion detecting unit checks whether a data section of the packet is matched with the data pattern information in order to determine whether the intrusion is detected or not.

### FIELD OF THE INVENTION

The present invention relates to a network intrusion detection; and, more particularly, to a security gateway system and a method using the same for detecting an intrusion.

### BACKGROUND OF THE INVENTION

Since 1980s, various intrusion detection systems have been developed. Those who have been devoted to the development of the intrusion detection systems define an intrusion to be a potential possibility of an intentional and illegal attempt to access to information, manipulate the information, and inactivate the systems. With the recognition of a need to develop the systems for detecting the intrusion thereinto, the researches are focused on a single host and then the range of the researches are expanded to a network including multiple hosts in response to developments of the Internet.

Accordingly, various systems for preventing the intrusion through a network have been developed. Examples thereof include RealSecure of ISS company, Netprowler of AXENT company, and the like.

A high-speed network such as a giga-bit Ethernet environment and data transmission/reception based thereon gradually affect applications of the intrusion detection systems. Further, since intrusion attempts are increased and diversified by the developments of the Internet, conventional low-speed intrusion detection techniques are required to be changed. In other words, in order to cope with a high-speed and high-capacity network environment and versified intrusion attempts, it is required to develop a technique capable of analyzing more data in a shorter time.

However, since most conventional intrusion detection systems are designed and applied for a single system environment or a low-speed network environment, it is difficult to apply the conventional systems to the high-speed and high-capacity network environment. Even if the conventional intrusion detection systems can be applied to the high-speed and high-capacity network environment, there are limits to enhance intrusion detection performances in application fields. Thus, researches are focused on improving an index of an intrusion detection performance, the index being indicated as a packet loss ratio and an intrusion detection ratio. Further, a change into a new network environment such as the giga-bit Ethernet environment accentuates an importance of such researches.

Accordingly, researches have been vitalized by a plurality of “Working Groups” of International Standard Organization (ISO) in order to solve problems of the performance of the intrusion detection systems and develop an improved system, thereby introducing a variety of products capable of detecting a high-speed intrusion. Most of such intrusion detection systems can guarantee detection of the intrusion in case data transmission rate is below 100 Mbps, and can be operated until the data transmission rate is 200 Mbps. In addition, those who have developed a certain essential technology provide intrusion detection system which can be applied to the giga-bit environment by embodying a function of the intrusion detection through hardwares.

However, even though such intrusion detection systems can be applied to the giga-bit environment, there are limits to improve a speed for collecting packets transmitted/received at high speed and detecting the intrusion.

### SUMMARY OF THE INVENTION

It is, therefore, a primary object of the present invention to provide a security gateway system and a method for detecting an intrusion, wherein the system and the method are capable of collecting packets and detecting the intrusion at high speed by detecting whether or not a header section and a data section of the packets, transmitted and received on a network, correspond to the intrusion in a hardware region and a kernel region, respectively.

It is another object of the present invention to provide a method for adding and deleting intrusion pattern information in the security gateway system, the security gateway system being capable of adding and deleting the intrusion pattern information in real-time, the intrusion pattern information being compared with the header section and the data section.

In accordance with one aspect of the present invention, there is provided a security gateway system for detecting an intrusion on a network, including: an intrusion pattern table including a header pattern table having header pattern information and the data pattern table having data pattern information which is connected to the header pattern information; a hardware intrusion detecting unit for collecting a packet transmitted and received on the network and checking whether a header section of the packet is matched with the header pattern information; and a kernel intrusion detecting unit for checking whether a data section of the packet is matched with the data pattern information, the packet having the header section matched with the header pattern information, to thereby detect an intrusion.

In accordance with another aspect of the present invention, there is provided a method for detecting an intrusion against a security gateway system including an intrusion pattern table having header pattern information and data pattern information which is connected to the header pattern information, the method including the steps of: (a) collecting a packet transmitted and received on a network by the security gateway system; (b) checking whether a header section of the collected packet is matched with header pattern information in a hardware region of the security gateway system; (c) inserting matching information into the packet in case the header section of the packet is matched with the header pattern information at the step (b) and then providing the packet containing the matching information to the security gateway system; (d) extracting at least one data pattern information connected to the header pattern information matched with the header section of the packet; (e) checking whether data section of the packet is matched with the extracted data pattern information in a kernel region of the security gateway system, the packets having the header section matched with the header pattern information; and (f) generating an intrusion alarm in case the data pattern information is matched with the data section of the packet.

In accordance with still another aspect of the present invention, there is provided a method for adding intrusion pattern information to an intrusion pattern table on a network including a security gateway system and a cyber patrol control system, the security gateway system having the intrusion pattern table containing a header pattern table and a data pattern table, the header pattern table containing header pattern information, the data pattern table containing data pattern information which is connected to the header pattern information, the method including the steps of: (a) receiving the intrusion pattern information from the cyber patrol control system; (b) classifying the received intrusion pattern information into the header pattern information and the data pattern information; (c) checking whether there exists the header pattern information matched with the classified header pattern information in the header pattern table; (d) adding the data pattern information connected to the header pattern information by using the classified data pattern information in case there exists the matched header pattern information in the header pattern table at the step (c); and (e) adding header pattern information to the header pattern table by using the classified header pattern information in case there exists no matched header pattern information in the header pattern table at the step (c) and then adding the data pattern information connected to the header pattern information to the data pattern table by using the classified data pattern information.

In accordance with still another aspect of the present invention, there is provided a method for deleting intrusion pattern information stored in an intrusion pattern table on a network including a security gateway system and a cyber patrol control system, the security gateway system having an intrusion pattern table containing a header pattern table and a data pattern table, the header pattern table containing header pattern information, the data pattern table containing data pattern information which is connected to the header pattern information, the method including the steps of: (a) receiving the intrusion pattern information to be deleted from the cyber patrol control system; (b) classifying the received intrusion pattern information into the header pattern information and the data pattern information; (c) checking whether there exists the data pattern information matched with the classified data pattern information in the data pattern table; (d) generating a pattern deletion error message if there is no matched data pattern information in the data pattern table at the step (c); and deleting matched data pattern information from the data pattern table if there exists data pattern information matched with the classified data pattern information at the step (c); (e) retrieving the header pattern information connected to the deleted data pattern information from the header pattern table; (f) checking whether there exists the data pattern information connected to the retrieved header pattern information in the data pattern table; and (g) keeping the header pattern information if there exists the data pattern information connected to the retrieved header pattern information in the data pattern table at the step (f); and deleting the retrieved header pattern information from the header pattern table if there exists no matched data pattern information in the data pattern table at the step (f).

### BRIEF DESCRIPTION OF THE DRAWINGS

The above and other objects and features of the present invention will become apparent from the following description of preferred embodiments, given in conjunction with the accompanying drawings, in which:

FIG. 1 shows a structure of a service network including security gateway systems in accordance with the present invention;

FIG. 2 illustrates a block diagram showing an overall structure of each security gateway system in accordance with the present invention;

FIG. 3 describes an intrusion detection table in the security gateway system in accordance with the present invention;

FIG. 4 depicts flows of input data and output data among a control and management unit, a kernel intrusion detecting unit and a hardware intrusion detecting unit of the security gateway system in accordance with the present invention;

FIG. 5 presents a detailed block diagram of the security gateway system in accordance with the present invention;

FIG. 6 represents a flow chart showing a process for detecting an intrusion by the security gateway system in accordance with the present invention;

FIG. 7 offers a flow chart showing a process for adding intrusion pattern information in the security gateway system in accordance with the present invention; and

FIG. 8 sets forth a flow chart showing a process for deleting intrusion pattern information in the security gateway system in accordance with the present invention.

### DETAILED DESCRIPTION OF THE PREFERRED EMBODIMENTS

Hereinafter, preferred embodiments of the present invention will be described in detail with reference to the accompanying drawings.

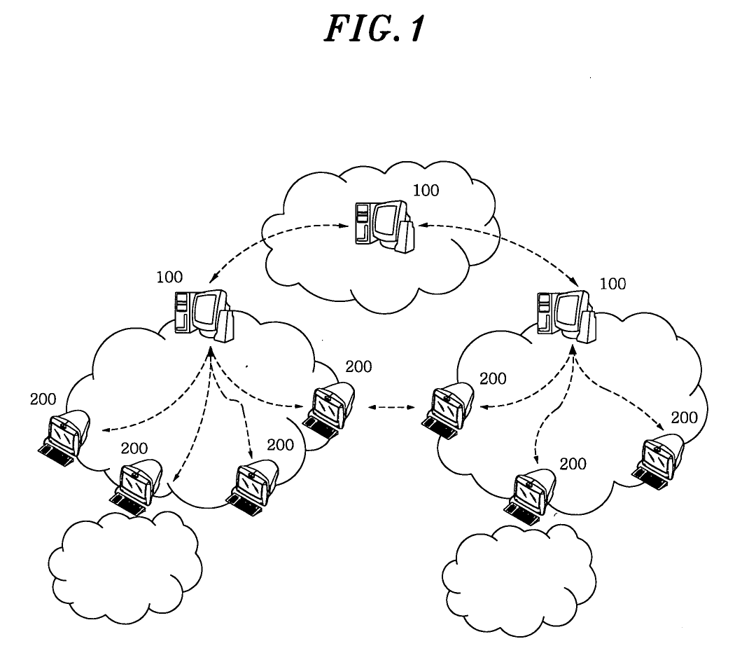

FIG. 1 shows a structure of a service network including security gateway systems in accordance with the present invention.

As illustrated in FIG. 1, the service network includes cyber patrol control systems 100 and security gateway systems 200.

Each of the cyber patrol control systems 100 receives intrusion alarm messages from its sub-systems, i.e., security gateway systems 200 and sets up policies corresponding to the intrusion alarm messages and then transmits the policies.

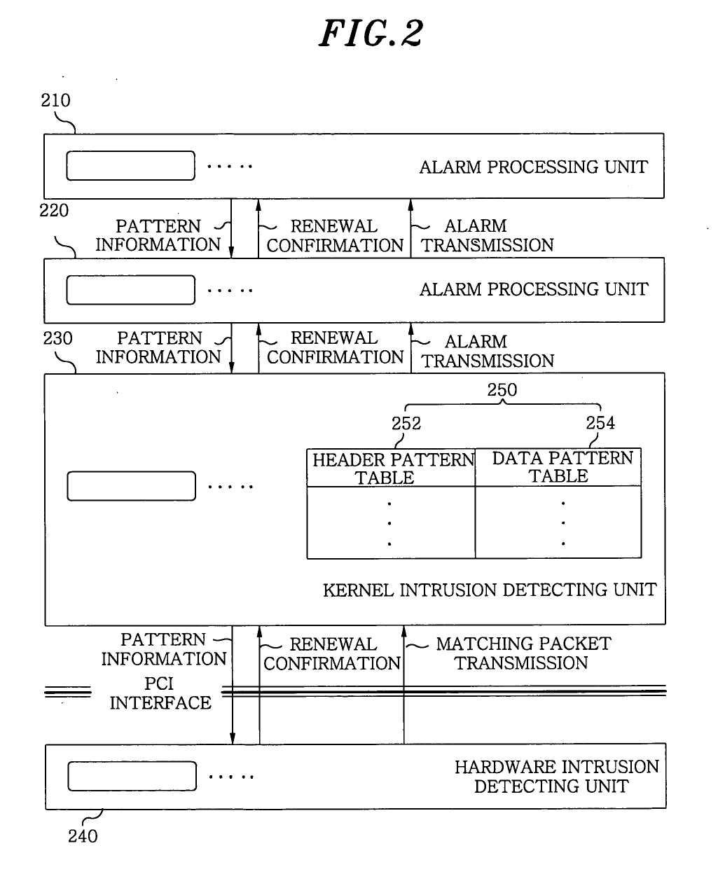

Each of the security gateway systems 200, scattered on the whole service network, collects packet transmitted/received in the network and then checks whether header section of the collected packet are matched with header pattern information. Thereafter, in case the header section of the packet is matched with one of the header pattern information, data section of the packet are checked whether it is same as data pattern information, to thereby detect an intrusion. A composition and an operation of a security gateway system 200 will be described with reference to FIGS. 2 to 5.

FIG. 2 illustrates a block diagram showing an overall structure of a security gateway system in accordance with the present invention. As shown in FIG. 2, the security gateway system 200 includes an alarm processing unit 210, a control and management unit 220, a kernel intrusion detecting unit 230, a hardware intrusion detecting unit 240, and an intrusion pattern table 250.

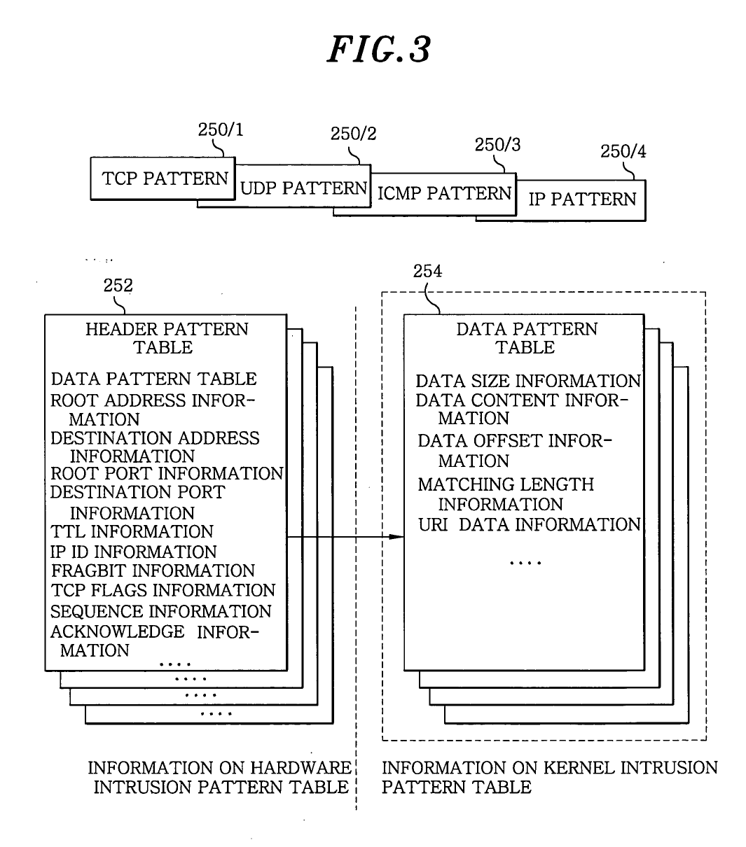

FIG. 3 describes an intrusion detection table in the security gateway system in accordance with the present invention. As can be seen from FIG. 3, the intrusion pattern table 250 includes a header pattern table 252 indicating header pattern information and a data pattern table 254 representing data pattern information, intrusion pattern information including the header pattern information and the data pattern information. The header pattern information stored in the header pattern table 252 and the data pattern information stored in the data pattern table 254 are applied to the hardware intrusion detecting unit 240 and the kernel intrusion detecting unit 230, respectively.

Information of the intrusion pattern table 250 is composed of a TCP pattern 250/1, a UDP pattern 250/2, an ICMP pattern 250/3 and an IP pattern 250/4. Compositions of the header pattern table 252 and the data pattern table 254 are determined according to information of each pattern 250/1-250/4. One header pattern table 252 includes one or more data pattern tables 254. Therefore, the intrusion pattern information can cover a type of the intrusion having a plurality of different data pattern information in same header pattern information.

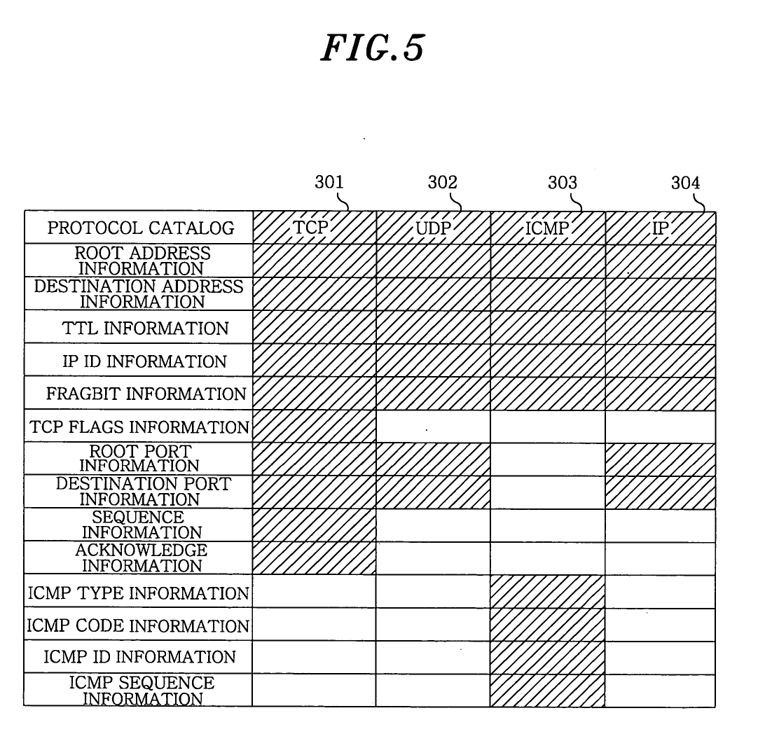

Information of the header pattern table 252 required by the TCP pattern 250/1, the UDP pattern 250/2, the ICPM pattern 250/3, and the IP pattern 250/4 are marked as oblique lines in FIG. 5.

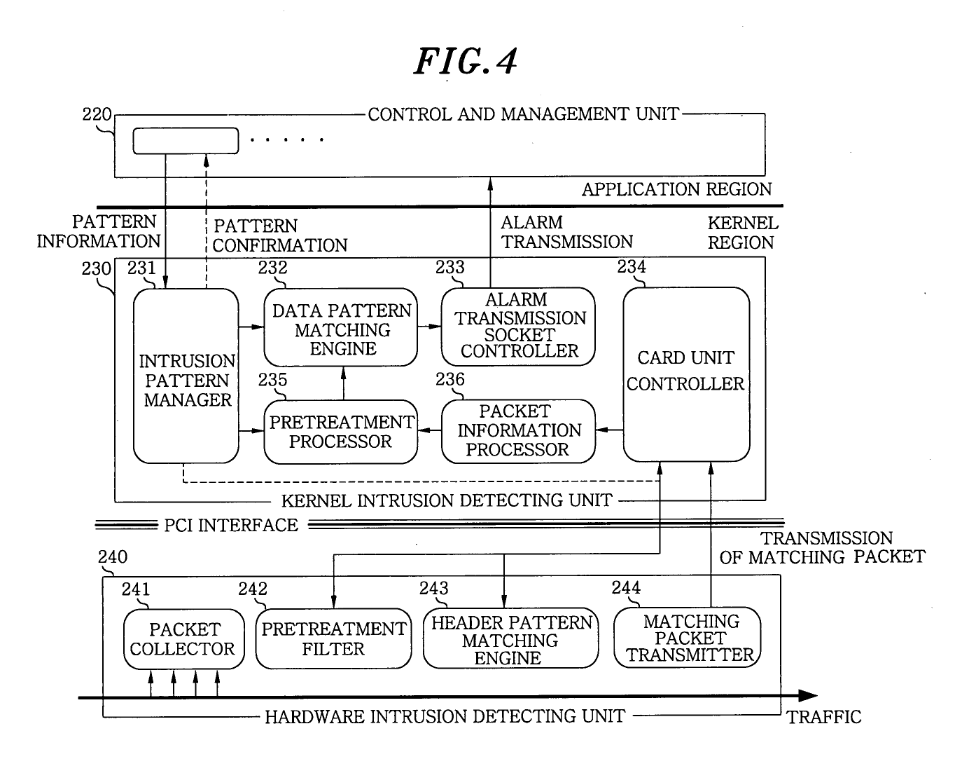

In order to perform an intrusion detection function at giga speed, the hardware intrusion detecting unit 240 carries out following processes: collecting network packet; inserting pretreatment information into the packet in case the packet requires a pretreatment process; comparing header section of the packet with header pattern information stored in the header pattern table 252 to thereby execute a heater pattern matching; and inserting matching information into the matched packets. The packets including the matching information and the pretreatment information are transmitted to the kernel intrusion detecting unit 230. As illustrated in FIG. 4, the hardware intrusion detecting unit 240 is composed of a packet collector 241, a pretreatment filter 242, a header pattern matching engine 243, and a matching packet transmitter 244.

The pattern collector 241 collects a packet in a network traffic and then provides the collected packet to the pretreatment filter 242. The pretreatment filter 242 checks whether the collected packet requires the pretreatment process and then inserts the pretreatment information into the packet in case the packet requires the pretreatment process. The packet including the pretreatment information is transmitted to the kernel intrusion detecting unit 230 by the pretreatment filter 242.

The header pattern matching engine 243 performs the header pattern matching by comparing the header section of the collected packet with the header pattern information stored in the header pattern table 252. In case the packet is matched, the header pattern matching engine 243 inserts the matching information into the matched packets, and then provides the packet including the matching information to the matching packet transmitter 244. The matching packet transmitter 244 transmits the packet including the matching information to the kernel intrusion detecting unit 230 in the kernel region. The kernel intrusion detecting unit 230 is connected to the hardware intrusion detecting unit 240 through a PCI interface. The matched packet is transmitted from the hardware intrusion detecting unit 240 to the kernel intrusion detecting unit 230 through the PCI interface. The hardware intrusion detecting unit 240 receives the header pattern information from the kernel intrusion detecting unit 230.

The kernel intrusion detecting unit 230 extracts the matching information or the pretreatment information from the packet transmitted from the hardware intrusion detecting unit 240. According to the extracted information, the kernel intrusion detecting unit 230 performs the pretreatment process or a data pattern matching for the packet.

In other words, the kernel intrusion detecting unit 230 checks whether the data section of the packet including the matching information is matched with the data pattern information stored in the data pattern table 254. In case the packet has the data section matched with one of the data pattern information, an intrusion alarm is generated based on the data pattern information matched with the data section of the packet. In case the packet includes the pretreatment information, the kernel intrusion detecting unit 230 removes noises from the packet or compares the packet with a preset pattern, to thereby determine whether the intrusion is detected or not. If the intrusion is detected, the intrusion alarm is generated. As can be seen from FIG. 4, the kernel intrusion detecting unit 230 includes an intrusion pattern manager 231, a data pattern matching engine 232, an alarm transmission socket controller 233, a card unit controller 234, a pretreatment processor 235, and a packet information processor 236.

The intrusion pattern manager 231 provides the header pattern information and the data pattern information retrieved from the intrusion pattern table 250 to the hardware intrusion detecting unit 240 and the data pattern matching engine 232 in the kernel intrusion detecting unit 230, respectively. Further, the intrusion pattern manager 231 receives the intrusion pattern information from the control and management unit 220, thereby updating the header pattern table and the data pattern table 254 stored in the intrusion pattern table 250.

The card unit controller 234 controls the packet containing the matching information and the packet including the pretreatment information received from the matching packet transmitter 244 and the pretreatment filter 242, respectively. The packet information processor 236 extracts the matching information or the pretreatment information from the packet received from the card unit controller 234. At this time, the packet containing the pretreatment information and the packet including the matching information are provided to the pretreatment processor 235 and the data pattern matching engine 232, respectively.

In case the packet containing the pretreatment information are identical to one of the preset intrusion patterns, the pretreatment processor 235 generates the intrusion alarm and transmits the generated intrusion alarm to the control and management unit 220 or removes noises from the packet.

The data pattern matching engine 232 compares the data pattern information of the data pattern table 254 with the data section of the packet containing the matching information in order to check whether the intrusion is detected or not. If the packet has the data section matched with the data pattern information, the data pattern matching engine 232 generates the intrusion alarm based on the data pattern information and provides the intrusion alarm to the alarm transmission socket controller 233.

The alarm transmission socket controller 233 provides the intrusion alarms generated by the pretreatment processor 235 and the data pattern matching engine 232 to the control and management unit 220 in an application layer region.

The control and management unit 220 generates the alarm message based on the intrusion alarm received from the alarm transmission socket controller 233 in the kernel intrusion detecting unit 230 and provides the alarm message to the alarm processing unit 210. Further, the control and management unit 220 receives the intrusion pattern information from the alarm processing unit 210 and provides it to the intrusion pattern manager 231.

The alarm processing unit 210 receives the alarm message from the control and management unit 220 and provides it to the cyber patrol control system 100. Further, the alarm processing unit 210 receives the intrusion pattern information to be added or deleted at preset intervals from the cyber patrol control system 100 and sends it to the control and management unit 220.

The intrusion pattern manager 231 receives the intrusion pattern information from the cyber patrol control system 100 sequentially by way of the alarm processing unit 210 and the control and the management unit 220, thereby updating the header pattern table 252 and the data pattern table 254 of the intrusion pattern table 250 in real-time.

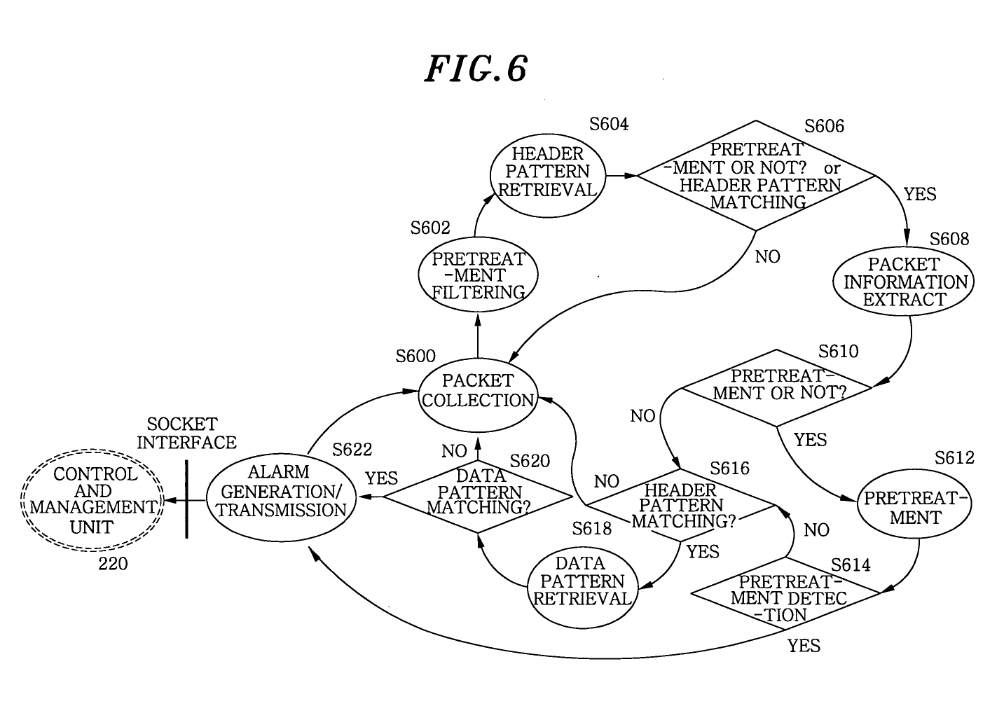

An operational process of the security gateway system 200 will be described with reference to FIG. 6. FIG. 6 represents a flow chart of the intrusion detection process of the security gateway system in accordance with the present invention.

Referring to FIG. 6, the hardware intrusion detecting unit 240 collects a packet transmitted and received on a network by using the packet collector 241 (S600) and checks whether the collected packet requires a pretreatment through the pretreatment filter 242. In case the packet requires the pretreatment, the hardware intrusion detecting unit 240 inserts pretreatment information into the packet and the packet containing the pretreatment information is provided to the card unit controller 234 (S602).

After the header pattern matching engine 243 performs the header pattern matching process, i.e., checking whether the header section of the collected packet is matched with the header pattern information provided from the intrusion pattern manager 231, and, in case the packet is matched, inserts the matching information into the packet (S604).

In this case, if the collected packet neither requires the pretreatment nor has the header section matched with the header pattern information as a result of the header pattern matching process, the hardware intrusion detecting unit 240 returns to the step S600 and then collects another packet.

However, in case the collected packet requires the pretreatment and has the header section matched with the header pattern information as a result of the header pattern matching process, the hardware intrusion detecting unit 240 provides the packet containing the pretreatment information or the packet containing the matching information to the card unit controller 234 in the kernel intrusion detecting unit 230 by using the pretreatment filter 242 or the matching packet transmitter 244, respectively (S606).

The card unit controller 234 provides the packet containing the pretreatment information or the packet containing the matching information to the packet information processor 236. The packet information processor 236 extracts information from the packet which is provided by the cared unit controller 234 (S608) and checks whether the packet requires the pretreatment by using the extracted information (S610).

If the packet requires the pretreatment at the step S610, the packet information processor 236 provides the packet to the pretreatment processor 235 in order to perform the pretreatment, i.e., removing noises from the packet (S612). Otherwise, the hardware intrusion detecting unit 240 checks whether the header pattern is matched (S616). If the intrusion is detected by comparing the noise-removed packet with preset intrusion pattern information while the pretreatment is performed (S614), the intrusion alarm is generated and transmitted (S622). If the intrusion is not detected, the intrusion alarm is not generated. In case the intrusion is detected, the pretreatment processor 235 generates the intrusion alarm and provides the generated intrusion alarm to the alarm transmission socket controller 233. Then, the alarm transmission socket controller 233 sends the intrusion alarm to the control and the management unit 220 (S622).

At this time, the hardware intrusion detecting unit 240 checks whether the header section of the packet requiring the pretreatment is matched with one of the header pattern information (S616). If the packet is not matched at the step S616, the security gateway system 200 returns to the step S600 for collecting another packet.

On the other hand, if it the packet is matched at the step 616, the hardware intrusion detecting unit 240 inserts the matching information into the packet and provides the packet to the kernel intrusion detecting unit 230 through the matching packet transmitter 244. At this time, the kernel intrusion detecting unit 230 retrieves data pattern information connected to the header pattern information matched with the header section of the packet (S618) and checks whether there exists the retrieved data pattern information matched with the data section of the packet (S620).

If there exists the retrieved data pattern information matched with the data section of the packet at the step S620, the kernel intrusion detecting unit 230 proceeds to the step S622 in order to generate the intrusion alarm and provide the generated intrusion alarm to the control and management unit 220. If there exists no matched data pattern information, the kernel intrusion detecting unit 230 proceeds to the step S600 for collecting another packet.

If the matching information is extracted from the packet at the step S608, the packet information processor 236 provides the packet to the data pattern matching engine 232. At this time, the intrusion pattern manager 231 retrieves the header pattern information matched with the header section of the packet from the header pattern table 252 and retrieves the data pattern information connected to the retrieved header pattern information from the data pattern table 254. Then, the retrieved data pattern information is transmitted to the data pattern matching engine 232.

The data pattern matching engine 232 checks whether the data pattern information is matched with the data section of the packet. In this case, if the data section of the packet is matched with one of the data pattern information, the data pattern matching engine 232 generates the intrusion alarm and provides the generated intrusion alarm to the control and management unit 220 through the alarm transmission socket controller 233. Otherwise, another packet is collected.

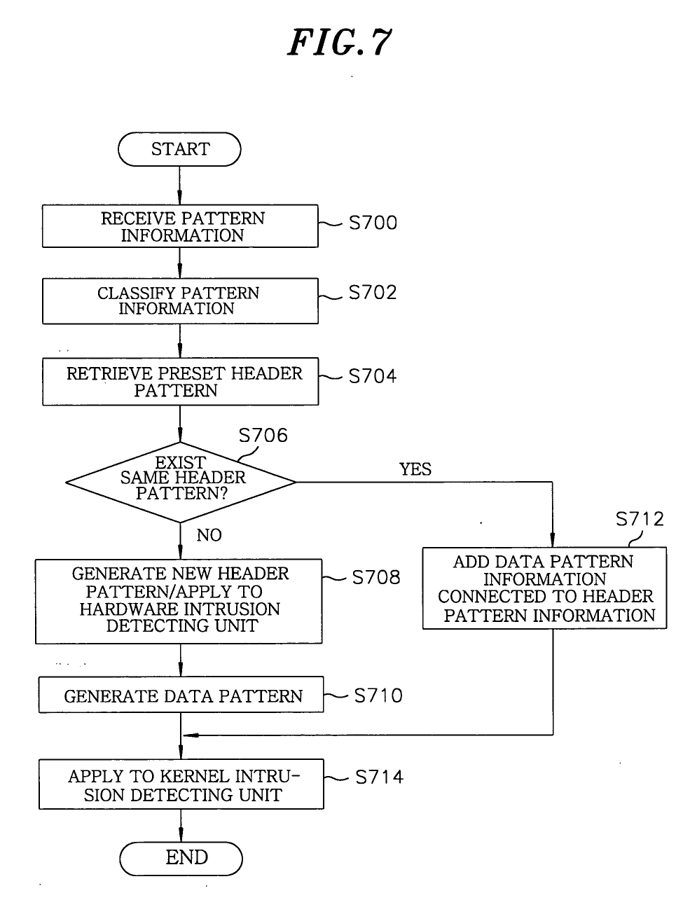

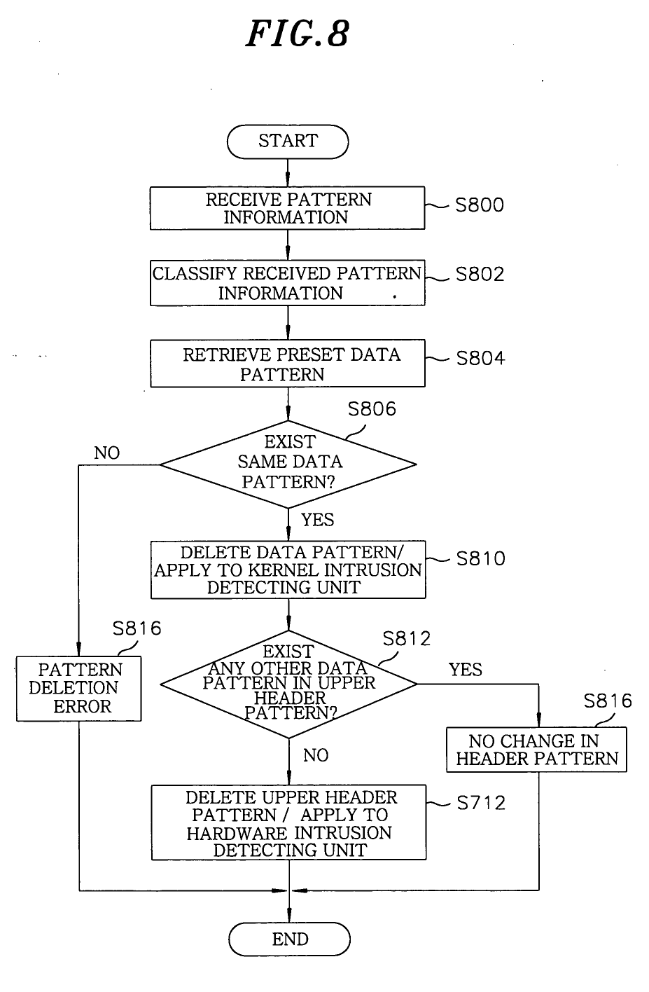

A process for updating the intrusion pattern information stored in the intrusion information table 250 by the security gateway system of the present invention will be described with reference to FIGS. 7 and 8. FIG. 7 offers a flow chart of a process for adding the intrusion pattern information to the intrusion information table in accordance with the present invention.

As shown in FIG. 7, the intrusion pattern manager 231 receives the intrusion pattern information transmitted at preset intervals from the cyber patrol control system 100 sequentially by way of the alarm processing unit 210 and the control and management unit 220 (S700). Then, the retrieved intrusion pattern information is classified into the header pattern information and the data pattern information (S702).

Next, the intrusion pattern manager 231 retrieves header pattern information from the header pattern table 252 of the intrusion information table 250 (S704) and then checks whether there exists header pattern information matched with the header section of the collected packet (S706).

If it is checked at the step S706 that there exists the matched header pattern information in the header pattern table 252, the intrusion pattern manager 231 generates data pattern information connected to the matched header pattern information in the data pattern table 254 by using classified data pattern information (S712). The newly generated data pattern information is applied to the kernel intrusion detecting unit 230 (S714).

If there exists no matched header pattern information in the header pattern table 252 at the step S706, the intrusion pattern manager 231 generates new header pattern information in the header pattern table 252 by using the classified header pattern information (S708) Further, the intrusion pattern manager 231 generates subordinate data pattern information of the new header pattern information in the data pattern table 254 by using the classified data pattern information (S710), thereby updating the header pattern table 252 and the data pattern table 254. The new header pattern information and the subordinate data pattern information are applied to the hardware intrusion detecting unit 240 and the kernel intrusion detecting unit 230, respectively (S714).

As described above, since the intrusion pattern table 250 is updated by receiving the intrusion pattern information from the cyber patrol control system 100 in real-time, various intrusion patterns can be detected, in accordance with the present invention.

Hereinafter, a process for deleting the intrusion pattern information by the security gateway system will be described with reference to FIG. 8. FIG. 8 sets forth a flow chart of a process for deleting the intrusion pattern information by the security gateway system in accordance with the present invention.

With reference to FIG. 8, the intrusion pattern manager 231 receives intrusion pattern information to be deleted, at preset intervals from the cyber patrol control system 100 sequentially via the alarm processing unit 210 and the control and management unit 220 (S800) and then classifies the received intrusion pattern information into header pattern information and data pattern information (S802).

The intrusion pattern manager 231 retrieves the data pattern information from the data pattern table 254 (S804) and checks whether the classified data pattern information is matched with one of the data pattern information of the data pattern table 254 (S806).

If the classified data pattern is not matched at the step 2806, the intrusion pattern manager 231 generates a pattern deletion error message (S808). Otherwise, the intrusion pattern manager 231 deletes the matched data pattern information from the data pattern table 254 (S810).

Next, the intrusion pattern manager 231 retrieves header pattern information connected to the deleted data pattern information in the header pattern table 252 and checks whether there exists any other data pattern information connected to the retrieved header pattern information, except the deleted data pattern information, in the data pattern table 254 (S812).

If there exists any other data pattern information in the header pattern information connected to the deleted data pattern information at the step S812, the intrusion pattern manager 231 does not delete the header pattern information connected to the deleted data pattern information (S814). Otherwise, the header pattern information connected to the deleted data pattern information is deleted (S816).

As described above, the present invention detects an intrusion by considering the hardware region and the kernel region in case the packet is transmitted and received on a network. In other words, the present invention performs a pattern matching at the hardware region, so that traffic of the PCI interface can be minimized. Therefore, a function of the pattern matching in the kernel region is minimized, thereby providing a high-speed intrusion detection function.

Further, the present invention collects packets and detects an intrusion at high speed by performing an intrusion detection by considering the hardware region and the kernel region in case the packets are transmitted and received on a network. Accordingly, it is possible to effectively and quickly perform an intrusion detection on a wide area network, thereby improving a detection efficiency and a system security.

While the invention has been shown and described with respect to the preferred embodiments, it will be understood by those skilled in the art that various changes and modifications may be made without departing from the spirit and scope of the invention as defined in the following claims.

What is claimed is:

1. A security gateway system for detecting an intrusion on a network, comprising:
an intrusion pattern table including a header pattern table having header pattern information and the data pattern table having data pattern information which is connected to the header pattern information;
a hardware intrusion detecting unit for collecting a packet transmitted and received on the network and checking whether a header section of the packet is matched with the header pattern information; and
a kernel intrusion detecting unit for checking whether a data section of the packet is matched with the data pattern information, the packet having the header section matched with the header pattern information, to thereby detect an intrusion.

2. The system of claim 1, wherein the kernel intrusion detecting unit generates an intrusion alarm in case the data section of the packet is matched with the data pattern information, and wherein the security gateway system further comprises:
a control and management unit for receiving the intrusion alarm from the kernel intrusion detecting unit and then generating an alarm message corresponding to the intrusion alarm; and
an alarm processing unit for transferring the alarm message from the control and management unit to a cyber patrol control system and receiving a policy corresponding to the alarm message from the cyber patrol control system.

3. The system of claim 1, wherein the hardware intrusion detecting unit includes:
a packet collector for collecting the packet transmitted and received on the network;
a pretreatment filter for inserting pretreatment information into the packet requiring a pretreatment and then transmitting the packet containing the pretreatment information to the kernel intrusion detecting unit;
a pattern matching engine for performing a header pattern matching by comparing the header section of the packet with the header pattern information and then inserting matching information into the packet in case the packet is matched; and
a matching packet transmitter for transmitting the packet containing the matching information to the kernel intrusion detecting unit.

4. The system of claim 1, wherein the kernel intrusion detecting unit includes:
a card unit controller for receiving the packet containing matching information and the packet containing pretreatment information from the hardware intrusion detecting unit;
a packet information processor for extracting the matching information and the pretreatment information from the packet received by the card unit controller;
a pretreatment processor for generating an intrusion alarm in case the intrusion is detected by comparing the packet containing the pretreatment information with a preset pattern based on the information extracted by the packet information processor;
a data pattern matching engine for generating the intrusion alarm in case the intrusion is detected by checking whether the data section of the packet containing the matching information is matched with the data pattern information; and
an alarm transmission socket controller for providing the intrusion alarms generated in the pretreatment processor and the data pattern matching engine to the control and management unit.

5. The system of claim 4, wherein the kernel intrusion detecting unit includes an intrusion pattern manager for providing the header pattern information and the data pattern information retrieved from the intrusion pattern table to the hardware intrusion detecting unit and the kernel intrusion detecting unit, respectively; and updating information stored in the intrusion pattern table by receiving intrusion pattern information at preset intervals from the control and management unit.

6. The system of claim 1, wherein the intrusion pattern table is composed of a TCP pattern, a UDP pattern, an ICMP pattern, and an IP pattern.

7. A method for detecting an intrusion against a security gateway system including an intrusion pattern table having header pattern information and data pattern information which is connected to the header pattern information, the method comprising the steps of:
(a) collecting a packet transmitted and received on a network by the security gateway system;
(b) checking whether a header section of the collected packet is matched with header pattern information in a hardware region of the security gateway system;
(c) inserting matching information into the packet in case the header section of the packet is matched with the header pattern information at the step (b) and then providing the packet containing the matching information to the security gateway system;
(d) extracting at least one data pattern information connected to the header pattern information matched with the header section of the packet;
(e) checking whether data section of the packet is matched with the extracted data pattern information in a kernel region of the security gateway system, the packet having the header section matched with the header pattern information; and
(f) generating an intrusion alarm in case the data pattern information is matched with the data section of the packet.

8. The method of claim 7, further comprising the steps of:
(d1) checking whether the packet collected on the network requires a pretreatment; and
(d2) removing noises from the packet in the kernel region in case the packet requires the pretreatment and then comparing the noise-removed packet with preset intrusion pattern information in order to determine whether the intrusion is detected or not, wherein the steps (d1) and (d2) are between the step (d) and the step (e).

9. A method for adding intrusion pattern information to an intrusion pattern table on a network including a security gateway system and a cyber patrol control system, the security gateway system having the intrusion pattern table containing a header pattern table and a data pattern table, the header pattern table containing header pattern information, the data pattern table containing data pattern information which is connected to the header pattern information, the method comprising the steps of:
(a) receiving the intrusion pattern information from the cyber patrol control system;
(b) classifying the received intrusion pattern information into the header pattern information and the data pattern information;
(c) checking whether there exists the header pattern information matched with the classified header pattern information in the header pattern table;
(d) adding the data pattern information connected to the header pattern information by using the classified data pattern information in case there exists the matched header pattern information in the header pattern table at the step (c); and
(e) adding header pattern information to the header pattern table by using the classified header pattern information in case there exists no matched header pattern information in the header pattern table at the step (c) and then adding the data pattern information connected to the added header pattern information to the data pattern table by using the classified data pattern information.

10. A method for deleting intrusion pattern information stored in an intrusion pattern table on a network including a security gateway system and a cyber patrol control system, the security gateway system having an intrusion pattern table containing a header pattern table and a data pattern table, the header pattern table containing header pattern information, the data pattern table containing data pattern information which is connected to the header pattern information, the method comprising the steps of:
(a) receiving the intrusion pattern information to be deleted from the cyber patrol control system;
(b) classifying the received intrusion pattern information into the header pattern information and the data pattern information;
(c) checking whether there exists the data pattern information matched with the classified data pattern information in the data pattern table;
(d) generating a pattern deletion error message if there is no matched data pattern information in the data pattern table at the step (c); and deleting matched data pattern information from the data pattern table if there exists data pattern information matched with the classified data pattern information at the step (c);
(e) retrieving the header pattern information connected to the deleted data pattern information from the header pattern table;
(f) checking whether there exists the data pattern information connected to the retrieved header pattern information in the data pattern table; and
(g) keeping the header pattern information if there exists the data pattern information connected to the retrieved header pattern information in the data pattern table at the step (f); and deleting the retrieved header pattern information from the header pattern table if there exists no matched data pattern information in the data pattern table at the step (f).
